(19) United States
(12) Patent Application Publication
(10) Pub. No.: US 2026/0012382 A1
(43) Pub. Date: Jan. 8, 2026

(54) METHODS AND SYSTEMS FOR HIGH-RANK MULTIPLE-INPUT MULTIPLE-OUTPUT (MIMO) SYMBOL DETECTION FOR MULTIPLE CODEWORDS

(71) Applicant: Samsung Electronics Co., Ltd., Suwon-si (KR)

(72) Inventor: Hyuk Joon Kwon, San Diego, CA (US)

(21) Appl. No.: 18/969,069

(22) Filed: Dec. 4, 2024

Related U.S. Application Data
(60) Provisional application No. 63/667,643, filed on Jul. 3, 2024.

(51) Int. Cl. H04L 27/14; H04B 7/0413

(52) U.S. Cl. CPC H04L 27/14; H04B 7/0413

(57) ABSTRACT

A method may include receiving a signal over a channel, decomposing the channel into a plurality of virtual channels, and performing symbol detection by two or more symbol detectors on the plurality of virtual channels. At least one of the two or more symbol detectors may include less than all of the plurality of virtual channels, and the method may include combining outputs from the two or more symbol detectors to obtain log likelihood ratio (LLR) values for layers of the channel.

### CROSS-REFERENCE TO RELATED APPLICATIONS

This application claims the priority benefit under 35 U.S.C. § 119(e) of U.S. Provisional Application No. 63/667,643, filed on July 3, 2024, the disclosure of which is incorporated by reference in its entirety as if fully set forth herein.

### FIELD

The present disclosure generally relates to wireless communication systems. More particularly, the subject matter disclosed herein relates to improvements to methods and systems for high-rank MIMO symbol detection for multiple codewords.

### SUMMARY

A modem of an electronic device may include a symbol detector for determining log-likelihood-ratio (LLR) values of coded bits from received signals. These LLR values may be used by a decoder of the modem to recover uncoded bits. When the number of layers (e.g., a rank) used for multiple-input multiple-output (MIMO) transmission increases, the complexity of symbol detection may increase. In long term evolution (LTE) and fifth generation new radio (5G NR), a maximum of eight transmit and eight receive antennas or panels may be utilized, and therefore, 8×8 or rank-8 symbol detectors are utilized.

Some MIMO symbol detectors may include, for example, maximum likelihood (ML), zero-forcing (ZF), minimum mean square error (MMSE), ZF/MMSE-successive interference cancelation (MMSE-SIC), and sphere decoder (SD) detectors. For high-rank scenarios, such as rank-8, existing linear symbol detectors, such as, for example, ZF and MMSE detectors, may have degraded performance due to their simple architectures. Some non-linear symbol detectors, such as, for example, ML, ZF/MMSE-SIC, and SD detectors, may perform well but may be too complex to be implemented. For example, ML detection provides that all symbols in a constellation are considered for LLR value calculation. Therefore, improvement to methods and systems for detecting multiple codewords for high-rank MIMO symbol detection are desired.

According to one or more embodiments, a method may include receiving a signal over a channel; decomposing the channel into a plurality of virtual channels; performing symbol detection by two or more symbol detectors on the plurality of virtual channels, wherein at least one of the two or more symbol detectors include less than all of the plurality of virtual channels; and combining outputs from the two or more symbol detectors to obtain log likelihood ratio (LLR) values for layers of the channel.

The performing the symbol detection may include performing a first symbol detection by a first symbol detector on each of the plurality of virtual channels from a first preprocessor.

The performing the symbol detection may further include performing a second symbol detection by a second symbol detector on each of the plurality of virtual channels from a second preprocessor, wherein the second symbol detector includes fewer layers than the first symbol detector.

The first symbol detector may be a rank-N/2 symbol and the second symbol detector may be a rank-N/4 symbol detector.

The decomposing the channel may include decomposing the channel by a first preprocessor, the method may further include receiving, by at least a second preprocessor, information from some of the plurality of virtual channels from the first preprocessor.

The performing the symbol detection may include: performing a first symbol detection by a first symbol detector on each of the plurality of virtual channels from the first preprocessor; and performing a second symbol detection by a second symbol detector on less than all of the plurality of virtual channels from the second preprocessor.

The decomposing the channel may be performed by at least the first preprocessor and the second preprocessor, and may include performing interference whitening on one or more layers of the channel.

The first symbol detector may be a rank-N/2 symbol detector and the first symbol detection may be performed on N/2 layers, and wherein the second symbol detector may be a rank-N/2 symbol detector, and the second symbol detection may be performed on N/4 layers.

The decomposing the channel may include decomposing the channel by a first preprocessor, the method may further include receiving, by at least a second preprocessor, information from some virtual channels of the plurality of virtual channels from the first preprocessor.

According to one or more embodiments, a system may include: a processor; and a memory storing instructions executed by the processor to cause the processor to: receive a signal over a channel; decompose the channel into a plurality of virtual channels; perform symbol detection by two or more symbol detectors on the plurality of virtual channels, wherein at least one of the two or more symbol detectors includes less than all of the plurality of virtual channels; and combine outputs from the two or more symbol detectors to obtain log likelihood ratio (LLR) values for layers of the channel.

The performing the symbol detection may include performing a first symbol detection by a first symbol detector on each of the plurality of virtual channels from a first preprocessor.

The performing the symbol detection may further include performing a second symbol detection by a second symbol detector on each of the plurality of virtual channels from a second preprocessor, wherein the second symbol detector includes fewer layers than the first symbol detector.

The first symbol detector may be a rank-N/2 symbol and the second symbol detector may be a rank-N/4 symbol detector.

The decomposing the channel may include decomposing the channel by a first preprocessor, and wherein the processor may further receive, by at least a second preprocessor, information from some of the plurality of virtual channels from the first preprocessor.

The performing the symbol detection may include: performing a first symbol detection by a first symbol detector on each of the plurality of virtual channels from the first preprocessor; and performing a second symbol detection by a second symbol detector on less than all of the plurality of virtual channels from the second preprocessor.

The decomposing the channel may be performed by at least the first preprocessor and the second preprocessor, and the processor further performs interference whitening on one or more layers of the channel.

The first symbol detector may be a rank-N/2 symbol detector and the first symbol detection may be performed on N/2 layers, and wherein the second symbol detector may be a rank-N/2 symbol detector, and the second symbol detection may be performed on N/4 layers.

The decomposing the channel may include decomposing the channel by a first preprocessor, and wherein the processor further receives, by at least a second preprocessor, information from some virtual channels of the plurality of virtual channels from the first preprocessor.

According to one or more embodiments, another method may include: receiving, by a first detector, a first signal over a first channel; decomposing the first channel into a plurality of virtual channels; performing first symbol detection, by a first symbol detector of the first detector, on each of the plurality of virtual channels from a first preprocessor of the first detector; receiving, by a second detector, a second signal over a second channel; decomposing the second channel into the plurality of virtual channels; performing second symbol detection, by a second symbol detector of the second detector, on some of the plurality of virtual channels from the first preprocessor of the second detector; receiving, by at least a second symbol detector of the first detector, information of the plurality of virtual channels from the second symbol detector of the second detector; combining outputs from the first and second symbol detectors of the first detector to obtain a first set of log likelihood ratio (LLR) values for layers of the first channel; and combining outputs from the first and second symbol detectors of the second detector to obtain a second set of LLR values for layers of the second channel.

The method may further include: performing a first decoding using the first set of LLR values to output a first decoded symbol value for the received first signal; and performing second decoding using the second set of LLR values to output a second decoded symbol value for the received second signal.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

In the following section, aspects of the subject matter disclosed herein will be described with reference to exemplary embodiments illustrated in the figures.

FIG. 1 is a block diagram illustrating a high-rank symbol detector, according to one or more embodiments.

FIG. 2 is a block diagram illustrating a rank-8 symbol detector using three rank-4 symbol detectors, according to one or more embodiments.

FIG. 3 is a block diagram illustrating a rank-4 symbol detector implemented with one rank-4 symbol detector and two rank-2 symbol detectors, according to one or more embodiments.

FIG. 4 is a block diagram illustrating a rank-8 symbol detector implemented using three rank-4 symbol detectors, according to one or more embodiments.

FIG. 5 is a block diagram illustrating a rank-8 symbol detector implemented using three rank-4 symbol detectors, according to one or more embodiments.

FIG. 6 is a block diagram illustrating two sets of rank-8 symbol detectors in parallel, according to one or more embodiments.

FIGS. 7, 8, 9, 10A, and 10B are flow charts of various methods for detecting codewords, according to one or more embodiments.

FIGS. 11-12 are block diagrams of an electronic device in a network environment, according to one or more embodiments of the present disclosure.

Embodiments of the present disclosure and their advantages are best understood by referring to the detailed description that follows. Unless otherwise noted, like reference numerals denote like elements throughout the attached drawings and the written description, and thus, descriptions thereof will not be repeated. In the drawings, the relative sizes of elements, layers, and regions may be exaggerated for clarity.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An electronic device such as a cellular phone may include modems that are used for communicating with base stations. Such modems may include multiple antennas for transmitting and receiving signals, and may also include one or more symbol detectors for determining log-likelihood-ratio (LLR) values of coded bits from received signals. These LLR values may then be used by a decoder of the modem to recover uncoded bits. However, when the number of layers (e.g., a rank) used for multiple-input multiple-output (MIMO) transmission increases, the complexity of symbol detection may increase. In long term evolution (LTE) and fifth generation new radio (5G NR), a maximum of eight transmit and eight receive antennas or panels may be utilized, and therefore, 8×8 or rank-8 symbol detectors are utilized. Accordingly, one or more embodiments of the present disclosure are directed to improving the detection of multiple codewords for high-rank MIMO symbols in modems of electronic devices such as 5G and LTE cellular phones.

According to embodiments of the present disclosure, virtual channel combining (VCC) may be performed using several lower rank symbol detectors, and resulting Euclidean distance (ED) values or LLR values may be combined to fulfill a high-rank symbol detector. VCC introduces another form of diversity gain in forming multiple virtual channels by preprocessing different selected layers of a channel over which a signal is received for each virtual channel. Accordingly, low complexity and high flexibility may be achieved for a high-rank MIMO receiver. The system may utilize any type of symbol detector having any rank at or below that of the channel in various combinations. For example, a rank-8 symbol detector may be implemented with 2 or more rank-4 symbol detectors. Alternatively, a rank-8 symbol detector may be implemented with 4 or more rank-2 symbol detectors. Throughout the present disclosure, references may be made with respect to specific rank sizes. However, it should be noted that such specific rank sizes are merely examples that are used to explain one or more embodiments of the present disclosure and that instead, the rank size may be any number N. Accordingly, a rank-N symbol detector may be implemented by 2 rank-N/2 symbol detectors or by 4 rank-N/4 detectors, and the like.

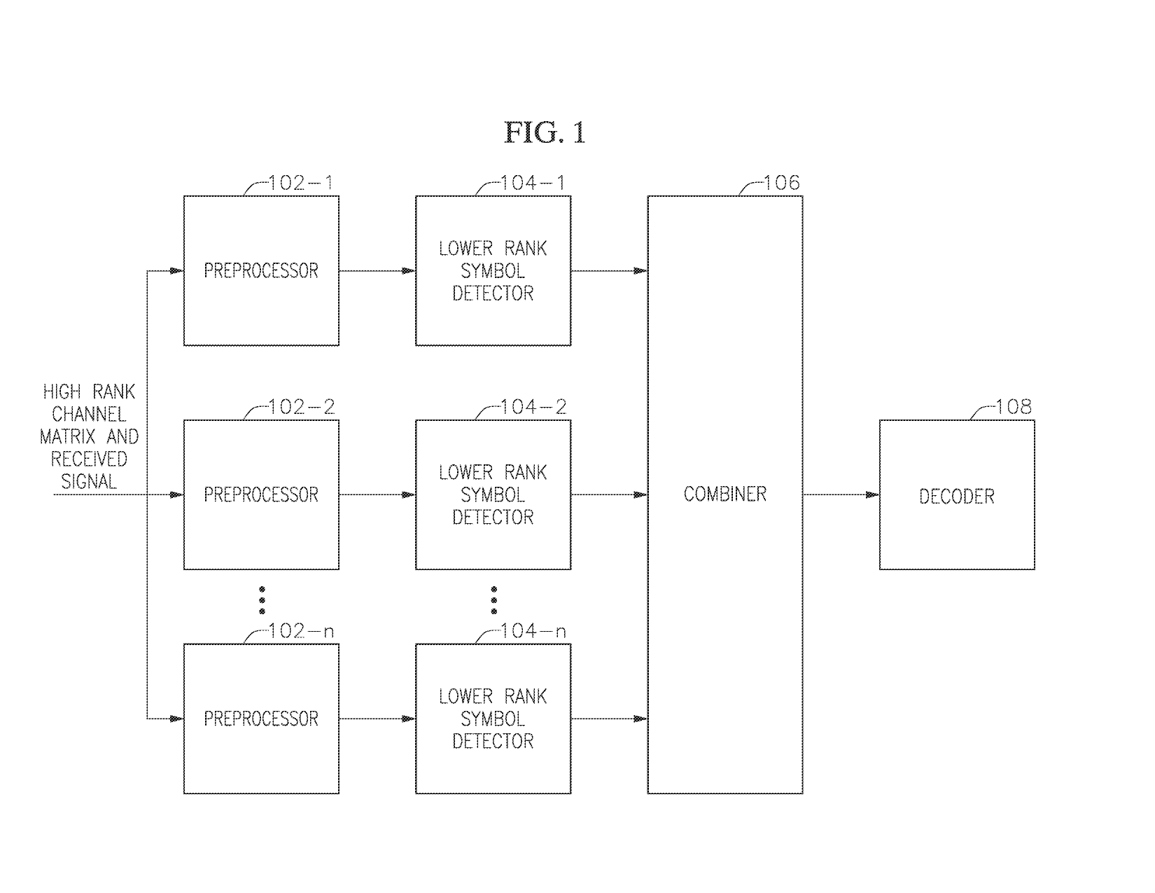

FIG. 1 is a block diagram illustrating a high-rank symbol detector implemented with multiple lower rank symbol detectors using a technique that may be referred to as sub-space diversity combining (SSDC) or virtual diversity combining (VDC), according to one or more embodiments. Given a signal received over a high-rank channel, preprocessing may be performed at preprocessors 102-1, 102-2, through 102-n to decompose the high-rank channel into several virtual channels with lower ranks. One example of a signal preprocessing scheme may be interference whitening (IW). Other preprocessing schemes may include, for example, interference cancellation, interference ignorance, and block-based IW. The layers of the original high-rank channel that remain in each virtual channel after signal preprocessing may be referred to as detection layers, which may be provided from each of the preprocessors 102-1, 102-2, through 102-n to respective lower rank symbol detectors 104-1, 104-2, through 104-n. Lower rank symbol detection may then be performed on the corresponding detection layers. The outputs of the lower rank symbol detectors 104-1, 104-2, through 104-n may be ED values or LLR values for the detection layers. An ED value combining scheme or an LLR value combining scheme may be performed at a combiner 106 to obtain final LLR values, corresponding to layers of the channel. A decoder 108 may use the final LLR values to obtain a decoded symbol value for the received signal.

Several ED or LLR combining schemes are described in greater detail below. However, embodiments of the present disclosure are not limited to LLR combining schemes and ED combining schemes. For example, one LLR combining scheme may be LLR summation in which several corresponding bit LLR values for different lower rank symbol detectors are summed to obtain the final LLR for that specific bit. Another LLR combining scheme may be LLR mean in which several corresponding bit LLR values for different lower rank symbol detectors are used to calculate its mean to obtain the final LLR value for that specific bit. Different mean calculation schemes may be applied, such as, for example, algebraic and geometric means. An additional LLR combining scheme may be LLR selection in which, among several corresponding bit LLR values for different lower rank symbol detectors, only one LLR is selected to obtain the final LLR for that specific bit. The LLR with the largest absolute value may be selected. However, other selection schemes may also be applied.

In ED combining, final EDs of 0 and 1 of each bit position of a modulation symbol may be determined by the minimum corresponding EDs from different lower rank symbol detectors. Final LLR = minED(1) − minED(0), where minED(1) and minED(0) are final minimum ED of bit 1 and bit 0 of a specific bit position of a specific modulation symbol.

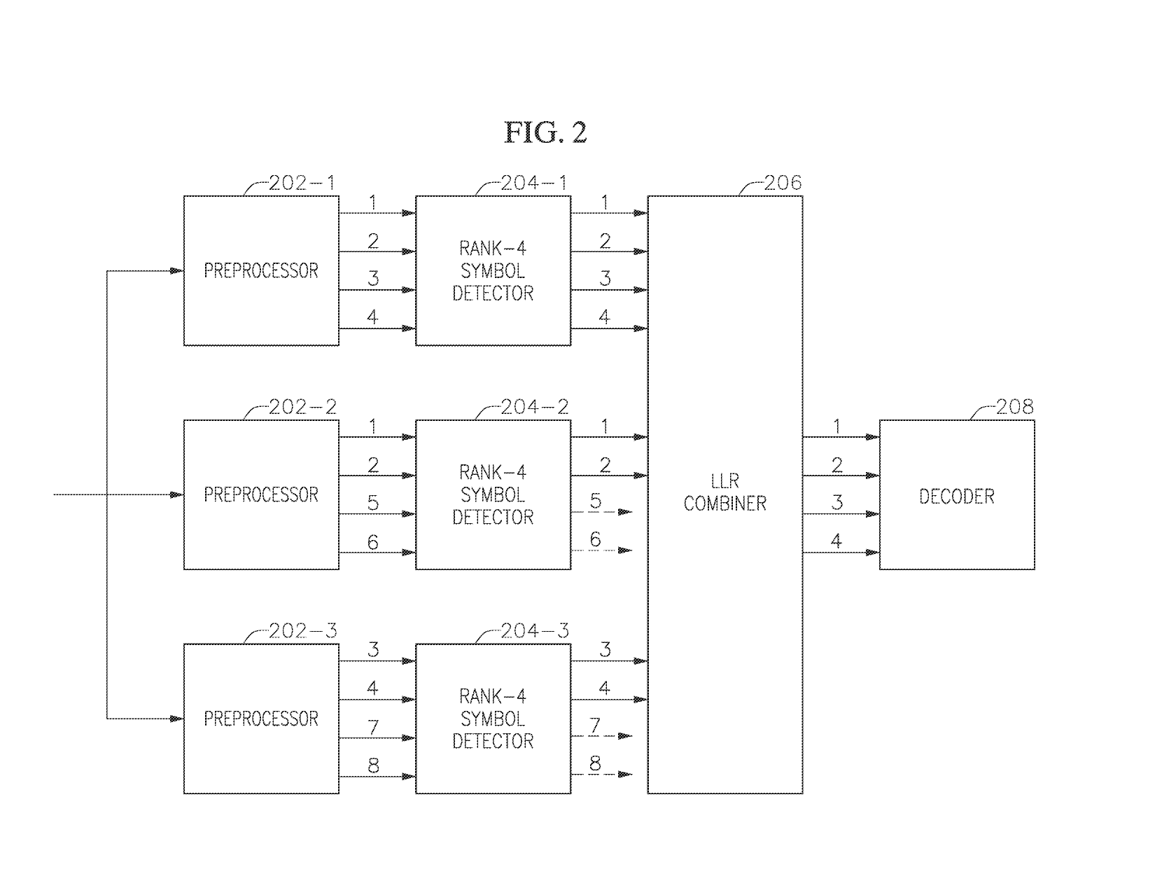

Referring now to FIG. 2, a block diagram illustrates a rank-N (e.g., rank-8) symbol detector implemented using three rank-N/2 (e.g., rank-4) symbol detectors, according to one or more embodiments. A rank-8 channel may include a first codeword (CW0) corresponding to layers 1-4 of the channel, and a second codeword (CW1) corresponding to layers 5-8 of the channel. Thus, FIG. 2 illustrates the processing of CW0, corresponding to layers 1-4 of the channel. Using IW as a preprocessing scheme, multiple virtual channels may be generated at preprocessors 202-1, 202-2, and 202-3. For example, at first preprocessor 202-1, IW is performed on layers [5678], resulting in detection layers [1, 2, 3, 4]. At second preprocessor 202-2, IW is performed on layers [3, 4, 7, 8], resulting in detection layers [1, 2, 5, 6]. At third preprocessor 202-3, IW is performed on layers [1, 2, 5, 6], resulting in detection layers [3, 4, 7, 8].

Each virtual channel may be provided to a rank-4 symbol detector. For example, symbol detection may be performed on detection layers [1, 2, 3, 4] at first rank-4 symbol detector 204-1. Symbol detection may be performed on detection layers [1, 2, 5, 6] at second rank-4 symbol detector 204-2. Symbol detection may be performed on detection layers [3, 4, 7, 8] at third rank-4 symbol detector 204-3. First through third rank-4 symbol detectors 204-1, 204-2, and 204-3 may generate LLR values (or ED values) for the layers of CW0 (e.g., [1, 2, 3, 4], [1, 2], and [3, 4]).

The LLR values (or ED values) may be combined at a combiner 206 using an LLR combining scheme (or ED combining scheme), and the resulting final LLR values may be fed from the combiner 206 to a decoder 208 to provide a decoded symbol value of the received signal. In some embodiments, using more virtual channels may help to further improve performance.

Second rank-4 symbol detector 204-2 and third rank-4 symbol detector 204-3 may have byproduct LLR values for layers [5, 6] and [7, 8] of the channel, respectively. Although these LLR values may not be used in decoding CW0, they may be saved and used in the subsequent decoding of CW1. The ranks of the lower rank symbol detectors and the layers for preprocessing may be selected in various ways, such as, for example, fixed selection based on experience or simulation results, and dynamic selection based on metrics (e.g., power of preprocessed layers) or prior knowledge of channel profiles. The ranks of the lower rank symbol detectors may not be the same, and the ranks of some lower rank symbol detectors may not necessarily be smaller than the rank of the channel.

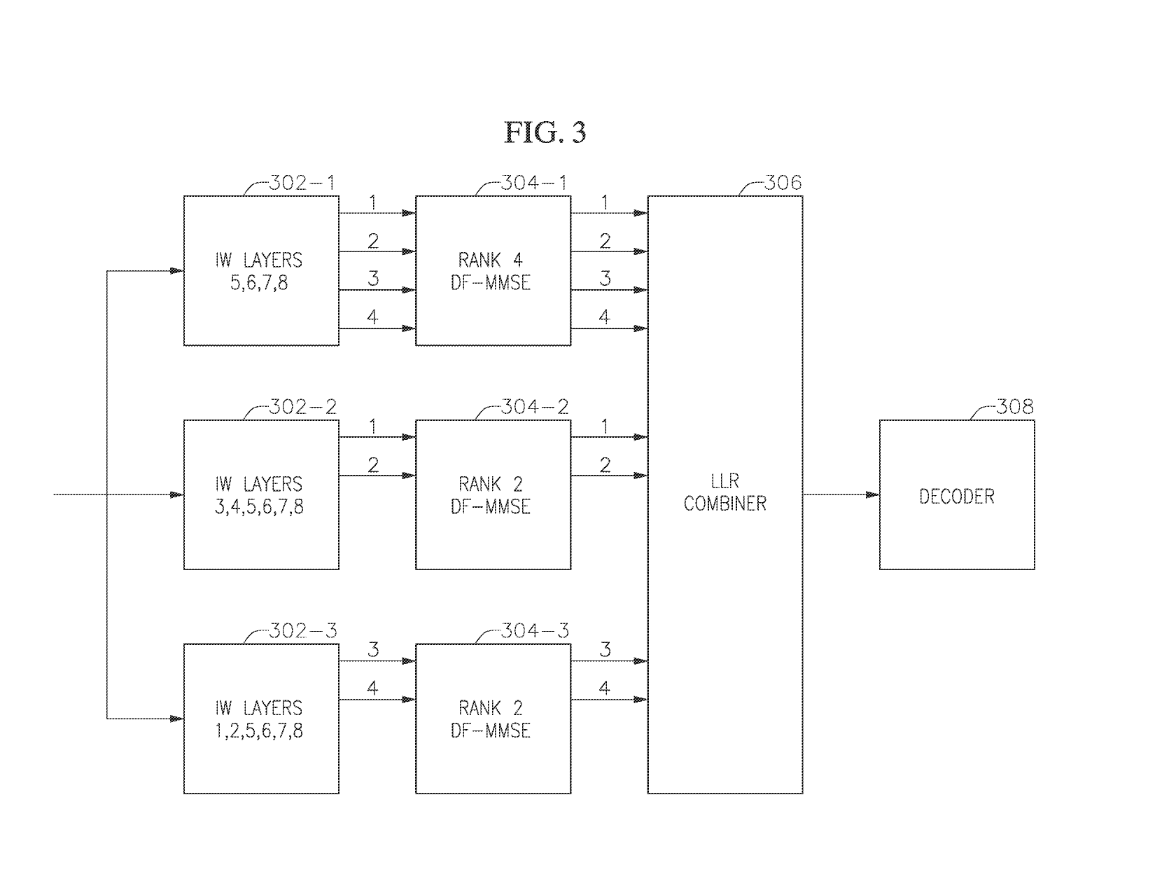

FIG. 3 is a block diagram illustrating a rank-N (e.g., rank-8) symbol detector implemented with one rank-N/2 (e.g., rank-4) symbol detector and two rank-N/4 (e.g., rank-2) symbol detectors, according to one or more embodiments, which may provide for reducing complexity and adding enhancements when multiple codewords are configured. For example, performing SSDC may result in a bottleneck while running the rank-4 matrix inverse m times (e.g., m = 3). However, instead of running the same form at each virtual path, the first path may convert the rank-8 equation into a rank-4 equation, and the second and third paths may instead use the form of rank-2 equations by taking a different IW. For example, using IW as a preprocessing scheme, multiple virtual channels may be generated. At first preprocessor 302-1, IW is performed on layers [5, 6, 7, 8] of the channel, resulting in detection layers [1, 2, 3, 4]. At second preprocessor 302-2, IW is performed on layers [3, 4, 5, 6, 7, 8] of the channel, resulting in detection layers [1, 2]. At third preprocessor 302-3, IW is performed on layers [1, 2, 5, 6, 7, 8] of the channel, resulting in detection layers [3, 4].

Symbol detection may be performed on detection layers [1, 2, 3, 4] at the rank-4 symbol detector 304-1. Symbol detection may be performed on detection layers [1, 2] at first rank-2 symbol detector 304-2. Symbol detection may be performed on detection layers [3, 4] at second rank-2 symbol detector 304-3. Symbol detectors 304-1, 304-2, and 304-3 may generate LLR values (or ED values) for the layers (e.g., [1, 2, 3, 4], [1, 2], and [3, 4]). The LLR values (or ED values) may be combined at a combiner 306 using an LLR combining scheme (or an ED combining scheme), and the resulting final LLR values may be fed from the combiner 306 to a decoder 308 to provide a decoded symbol value of the received signal.

In some embodiments, the IW for the second and third paths may be computed starting from this equation and not directly by taking the inverse of the layers, e.g., layers 3, 4, 5, 6, 7, or 8. Therefore, multiplication and addition (or subtraction) may be performed to compute the pre-processing to transmit the original rank-8 equation into the rank-2 equations without having to compute the matrix inverse, thereby avoiding or reducing the potential for a bottleneck operation.

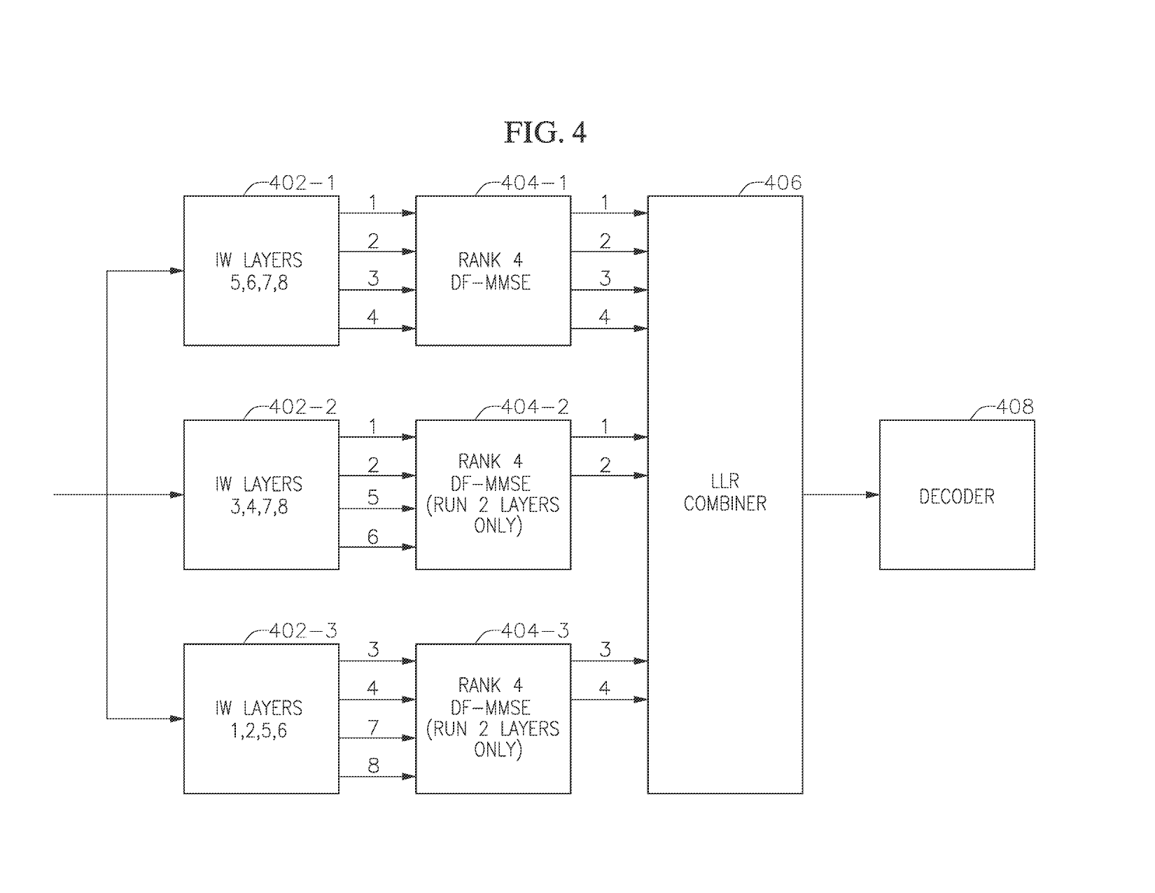

FIG. 4 is a block diagram illustrating a rank-N (e.g., rank-8) symbol detector implemented using three rank-N/2 (e.g., rank-4) symbol detectors, according to one or more embodiments. A rank-8 channel may include a first codeword (CW0), corresponding to layers 1-4 of the channel, and a second codeword (CW1), corresponding to layers 5-8 of the channel. Similar to FIG. 2, FIG. 4 illustrates the processing of CW0, corresponding to layers 1-4 of the channel. Using IW as a preprocessing scheme, multiple virtual channels may be generated at preprocessors 402-1, 402-2, and 402-3. For example, at first preprocessor 402-1, IW may be performed on layers [5678], resulting in detection layers [1, 2, 3, 4]. At second preprocessor 402-2, IW may be performed on layers [3, 4, 7, 8], resulting in detection layers [1, 2, 5, 6]. At third preprocessor 402-3, IW may be performed on layers [1, 2, 5, 6], resulting in detection layers [3, 4, 7, 8].

In some embodiments, each virtual channel may be provided to a corresponding rank-4 symbol detector. For example, symbol detection may be performed on detection layers [1, 2, 3, 4] at first rank-4 symbol detector 404-1. However, differently from the first rank-4 symbol detector 404-1, the second rank-4 symbol detector 404-2 may perform detection on only layers [1, 2], and the third rank-4 symbol detector 404-3 may perform detection on only layers [3, 4]. In other words, the second rank-4 symbol detector 404-2 and the third rank-4 symbol detector 404-3 do not run detection on half of the layers, therefore improving timing of the processing by about 25% because only 8 layers are run instead of 12 layers (as in the detector in FIG. 2) over three virtual paths.

The LLR values (or ED values) may be combined at a combiner 406 using an LLR combining scheme (or ED combining scheme), and the resulting final LLR values may be fed from the combiner 406 to a decoder 408 to provide a decoded symbol value of the received signal.

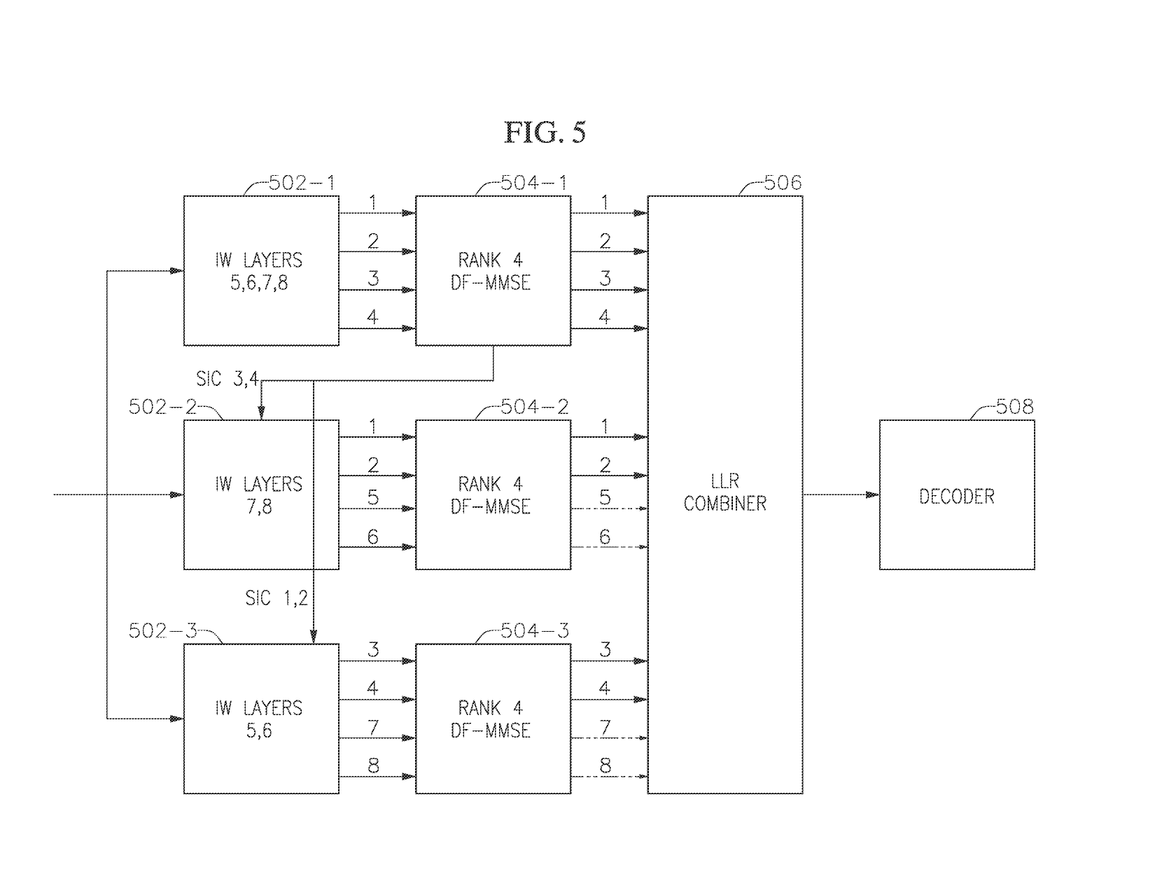

FIG. 5 is a block diagram illustrating a rank-N (e.g., rank-8) symbol detector implemented using three rank-N/2 (e.g., rank-4) symbol detectors, according to one or more embodiments. The configuration is similar to that of FIG. 2, wherein by using IW as a preprocessing scheme, multiple virtual channels are generated at preprocessors 502-1, 502-2, and 502-3. For example, at first preprocessor 502-1, IW is performed on layers [5678], resulting in detection layers [1, 2, 3, 4]. Each virtual channel from the first preprocessor 502-1 may be provided to a first rank-4 symbol detector 504-1 to perform symbol detection on layers [1, 2, 3, 4].

However, differently from FIG. 2, at second preprocessor 502-2, IW is performed on only layers [7, 8], and at third preprocessor 502-3, IW is performed on only layers [5, 6]. Furthermore, instead of performing IW on layers [3, 4] at the second preprocessor 502-2, an output from the first rank-4 symbol detector 504-1 may be provided to the second preprocessor 502-2 and may utilize this information that was already computed by the first rank-4 detector 504-1 to cancel layers [3, 4] from the second preprocessor 504-2. Similarly, instead of performing IW on layers [1, 2] at the third preprocessor 502-3, an output from the first rank-4 symbol detector 504-1 may be provided to the third preprocessor 502-3 and may utilize this information that was already computed by the first rank-4 detector 504-1 to cancel layers [1, 2] from the third preprocessor 504-2. Accordingly, complexity may be avoided or reduced by reducing the effective number of layers for which IW is perform.

In some embodiments, each virtual channel may be provided to a rank-4 symbol detector. For example, in addition to performing symbol detection on detection layers [1, 2, 3, 4] at first rank-4 symbol detector 504-1, symbol detection may further be performed on detection layers [1, 2, 5, 6] at second rank-4 symbol detector 504-2, and symbol detection may be performed on detection layers [3, 4, 7, 8] at third rank-4 symbol detector 504-3. First through third rank-4 symbol detectors 504-1, 504-2, and 504-3 may generate LLR values (or ED values) for the layers of CW0 (e.g., [1, 2, 3, 4], [1, 2, 5, 6], and [3, 4, 7, 8]).

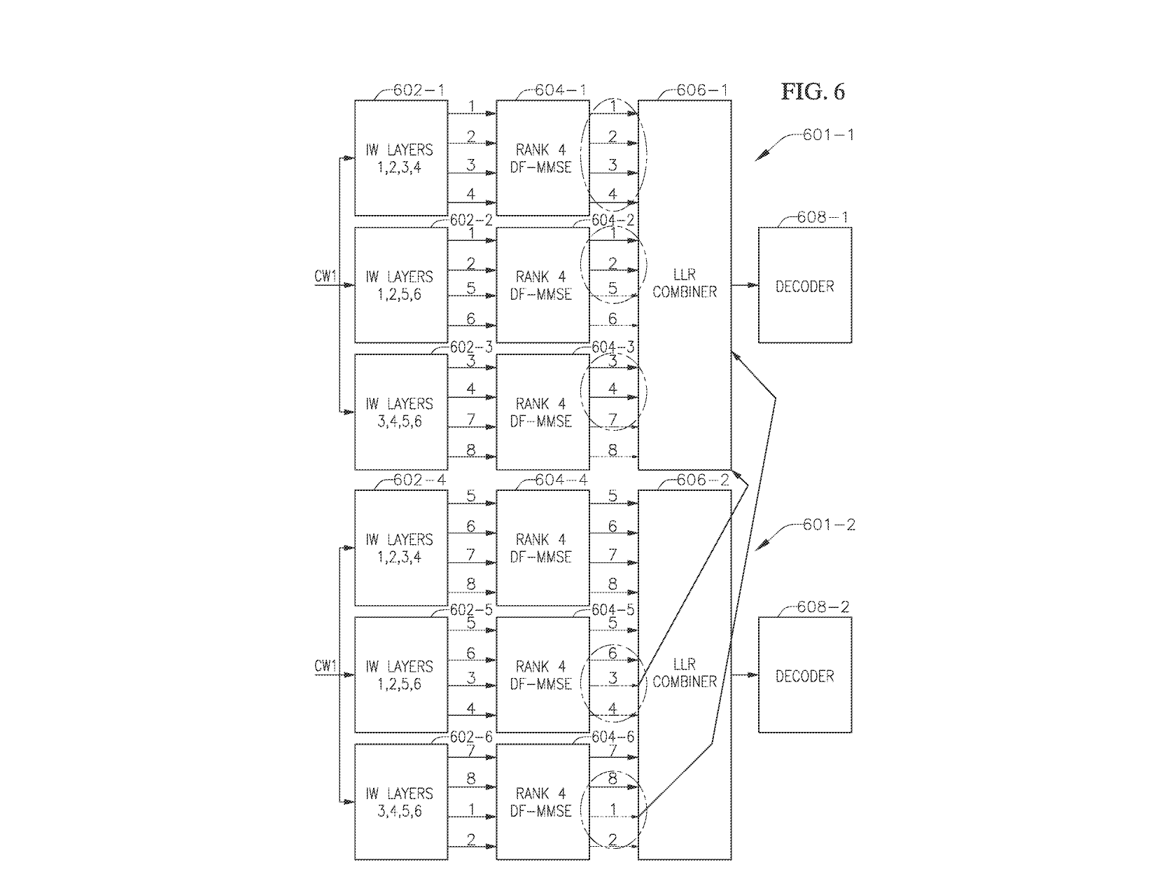

FIG. 6 is a block diagram illustrating two sets of rank-N (e.g., rank-8) symbol detectors in parallel, according to one or more embodiments. Each of the two rank-8 symbol detectors (e.g., detector 601-1 and second detector 601-2) may be identical to the detector illustrated in FIG. 2. Therefore, information from the output from a low-rank symbol detection in a virtual path of one detector may be utilized by the virtual path of the other detector. For example, when multiple codewords (e.g., CW0 and CW1) are configured and those codewords are simultaneously detected, the sub-layers that are considered interferences in one detector for the first codeword may be utilized as serving layers in the other detector for the second codeword. In some embodiments, even if the codewords are sequentially detected (rather than simultaneously), the information from the first codeword from one detector may be saved until the second codeword from the other detector is detected. Therefore, multiple detectors may be implemented in parallel and the information from one detector may be shared with the other detector, thereby reducing the amount of computing that the other detector may perform.

For example, in a rank-8 channel that includes a first codeword (CW0) and a second codeword (CW1), the processing of CW0 may correspond to layers 1-4 of the channel and the processing of CW1 may correspond to layers 5-8 of the channel. The first detector 601-1 may be configured to detect layers 1-4 corresponding to CW0 and the second detector 601-2 may be configured to detect layers 5-8 corresponding to CW1. Thus, if using IW as a preprocessing scheme, then IW may be performed on layers [5678] at the first preprocessor 602-1 of the first detector 601, resulting in detection layers [1, 2, 3, 4]. At second preprocessor 602-2, IW may be performed on layers [3, 4, 7, 8], resulting in detection layers [1, 2, 5, 6]. At third preprocessor 602-3, IW may be performed on layers [1, 2, 5, 6], resulting in detection layers [3, 4, 7, 8]. However, because the first detector 601-1 does not need layers [5, 6, 7, 8] for CW0, rather than allowing the detection of these layers go to waste, they may be utilized by the second detector 601-2 for detecting CW1 which correspond to layers [5, 6, 7, 8]. Thus, FIG. 6 shows that the rank-4 detection results from the second rank-4 symbol detector 604-2 from the first detector 601-1 may be used by the second rank-4 symbol detector 604-5 of the second detector 601-2, and third rank-4 symbol detector 604-3 of the first detector may be used by third rank-4 symbol detector 604-6 of the second detector 604-2, thereby enhancing performance of the detector without adding a complex computing block. Similarly, the rank-4 detection results from the second rank-4 symbol detector 604-5 from the second detector 601-2 may be used by the second rank-4 symbol detector 604-3 of the first detector 601-1, and third rank-4 symbol detector 604-5 of the second detector 601-2 may be used by third rank-4 symbol detector 604-3 of the first detector 601-1, thereby enhancing performance of the detector without adding a complex computing block.

The LLR values (or ED values) may be combined at the first and second combiners 606-1, 606-2, respectively, using an LLR combining scheme (or ED combining scheme), and the resulting final LLR values may be fed from the first and second combiners 606-1, 606-2, to first and second decoders 608-1, 608-2, respectively, to provide a decoded symbol value of the received signal.

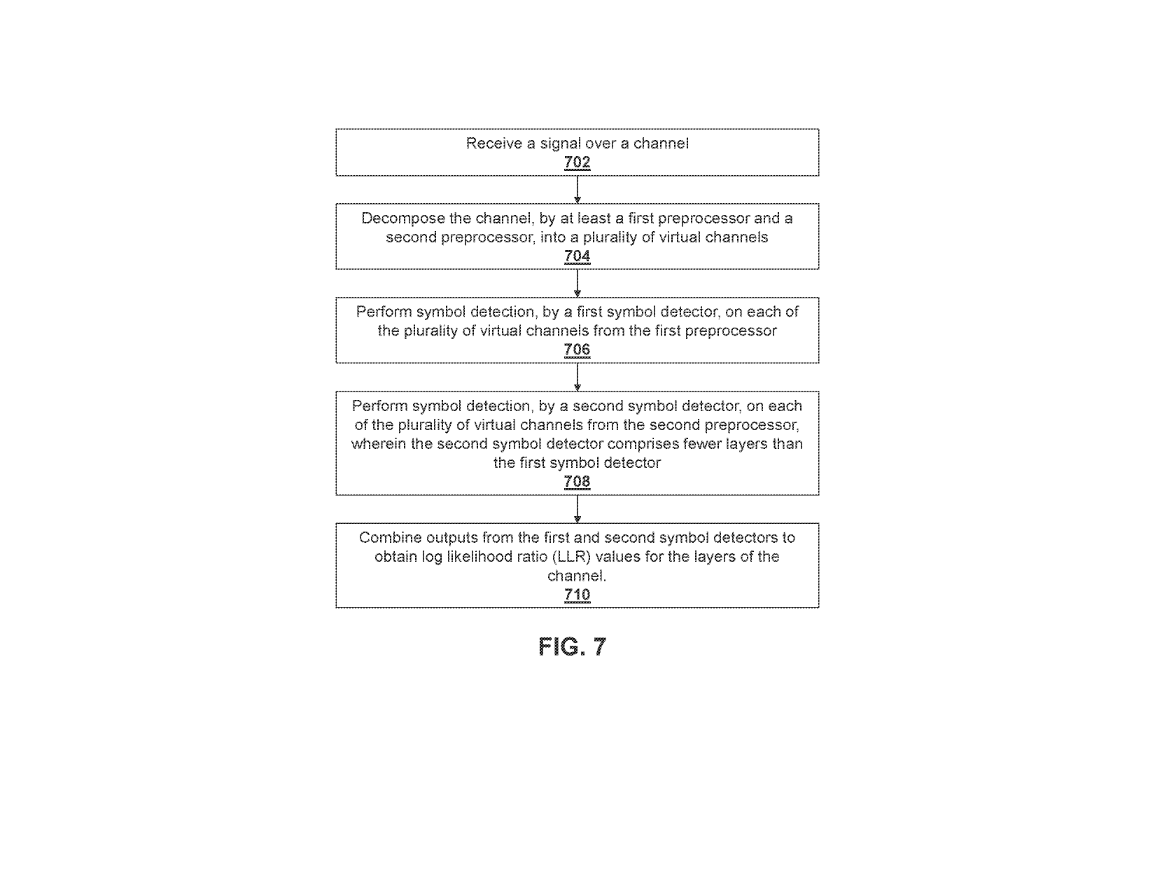

FIG. 7 is a flow chart illustrating a method for high-rank symbol detection, according to one or more embodiments. Although FIG. 7 illustrates various operations in a process for symbol detection, embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of embodiments according to the present disclosure.

Turning to FIG. 7, a high-rank symbol detector such as the one illustrated in FIG. 3 may be configured to receive a signal over a channel at operation 702. For example, the detector may include a plurality of preprocessors, each connected to symbol detectors such as one rank-N/2 symbol detector and a plurality of rank-N/4 symbol detectors. The channel may then be decomposed by at least a first preprocessor and a second preprocessor into a plurality of virtual channels at operation 704. In some embodiments, the decomposing may include interference whitening (IW) on one or more layers of the channel. The first symbol detector, which may be a rank-N/2 symbol detector may perform symbol detection on each of the plurality of virtual channels from the first preprocessor at operation 706. A second symbol detector, which may be a rank-N/2 symbol detector, may perform symbol detection on each of the plurality of virtual channels from the second preprocessor at operation 708. As the first symbol detector may be a rank-N/2 symbol detector and the second symbol detector may be a rank-N/4 symbol detector, the second symbol detector includes fewer layers than the first symbol detector. Finally, the outputs from the first and second symbol detectors may be combined to obtain log likelihood ratio (LLR) values for the layers of the channel at operation 710. In some embodiments, the LLR values may be decoded to output decoded symbol value for the received signal.

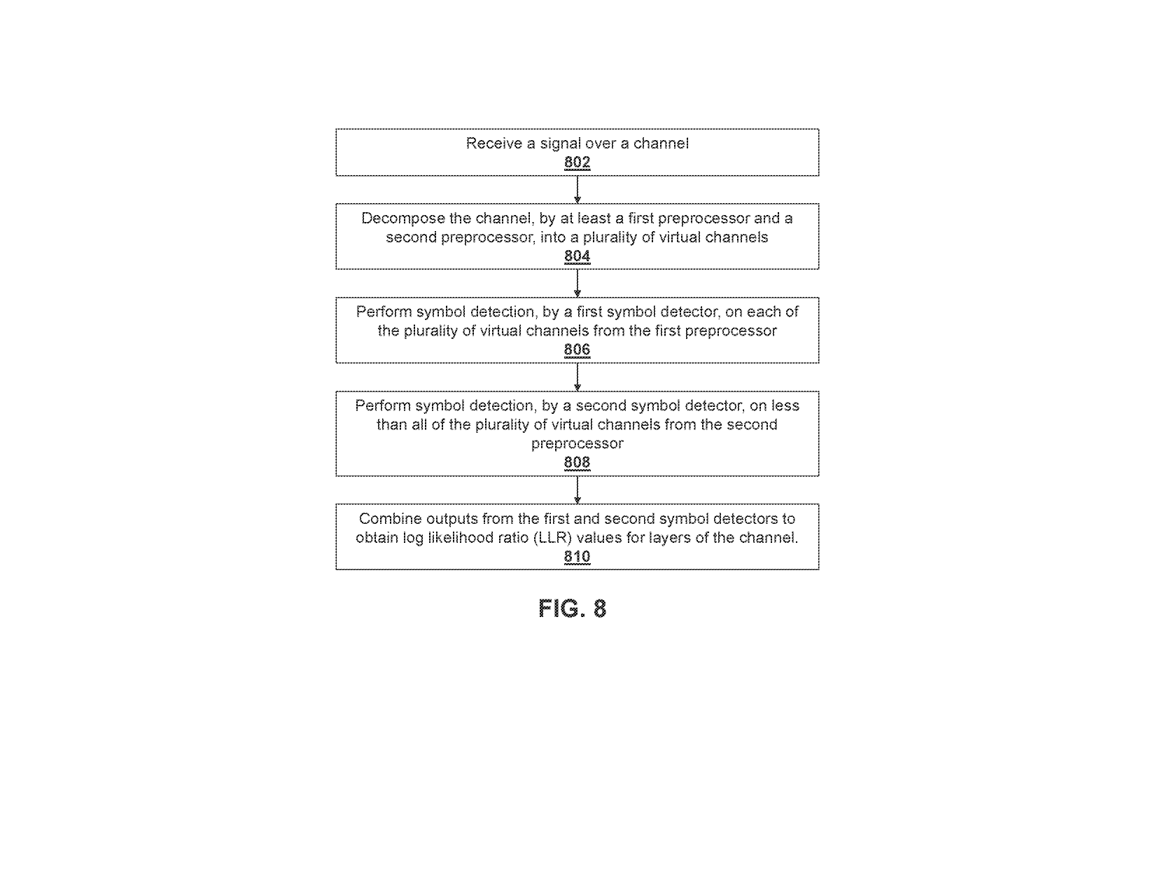

FIG. 8 is a flow chart illustrating another method for high-rank symbol detection, according to one or more embodiments. Although FIG. 8 illustrates various operations in a process for symbol detection, embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of embodiments according to the present disclosure.

Turning to FIG. 8, a high-rank symbol detector such as the one illustrated in FIG. 4 may be configured to receive a signal over a channel at operation 802. For example, the detector may include a plurality of preprocessors, each connected to symbol detectors such as a plurality of rank-N/2 symbol detectors. The channel may then be decomposed by at least a first preprocessor and a second preprocessor into a plurality of virtual channels at operation 804. In some embodiments, the decomposing may include interference whitening (IW) on one or more layers of the channel. The first symbol detector, which may be a rank-N/2 symbol detector may perform symbol detection on each of the plurality of virtual channels from the first preprocessor at operation 806. A second symbol detector, which may also be a rank-N/2 symbol detector, may perform symbol detection on less than all of the plurality of virtual channels from the second preprocessor at operation 808. For example, the first symbol detector may perform symbol detection on four virtual channels and the second symbol detector may perform symbol detection on two virtual channels. Finally, the outputs from the first and second symbol detectors may be combined to obtain LLR values for the layers of the channel at operation 810. In some embodiments, the LLR values may be decoded to output decoded symbol value for the received signal.

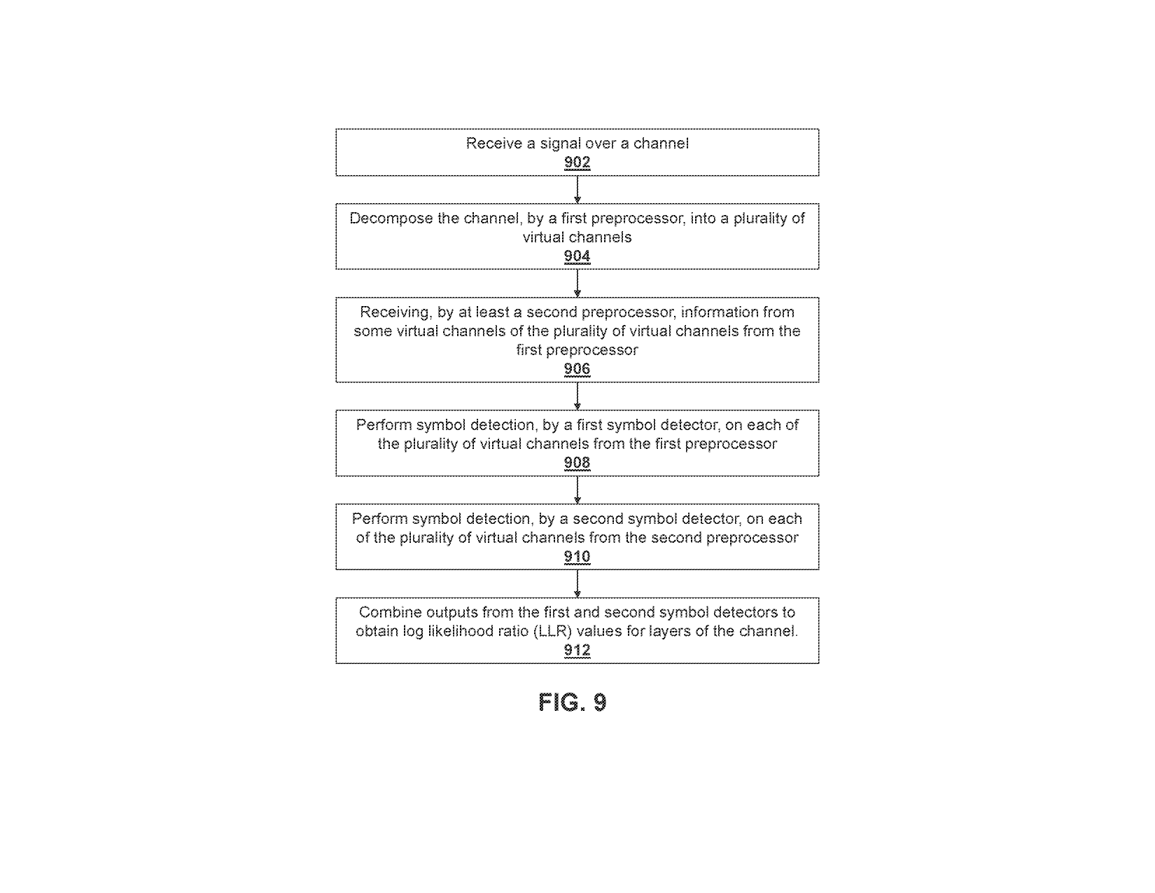

FIG. 9 is a flow chart illustrating another method for high-rank symbol detection, according to one or more embodiments. Although FIG. 9 illustrates various operations in a process for symbol detection, embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of embodiments according to the present disclosure.

Turning to FIG. 9, a high-rank symbol detector such as the one illustrated in FIG. 5 may be configured to receive a signal over a channel at operation 902. For example, the detector may include a plurality of preprocessors, each connected to symbol detectors such as a plurality of rank-N/2 symbol detectors. The channel may then be decomposed by a first preprocessor into a plurality of virtual channels at operation 904. In some embodiments, the decomposing may include interference whitening (IW) on one or more layers of the channel. In some embodiments, at least a second preprocessor may receive information from some virtual channels of the plurality of virtual channels from the first preprocessor at operation 906 so that the second preprocessor does not have to perform preprocessing, or so that the second preprocessor may perform less preprocessing than it would have to perform if it did not receive the information from the first preprocessor. The first symbol detector may then perform symbol detection on each of the plurality of virtual channels from the first preprocessor at operation 908, and the second symbol detector may perform symbol detection on each of the plurality of virtual channels from the second preprocessor at operation 910. In some embodiments, the first and second symbol detectors may be a rank-N/2 symbol detector. It should be noted that additional symbol detectors, for example, a third symbol detector may also perform symbol detection on each of the plurality of virtual channels from a third preprocessor. Finally, the outputs from the first and second symbol detectors may be combined to obtain LLR values for the layers of the channel at operation 810. In some embodiments, the LLR values may be decoded to output decoded symbol value for the received signal.

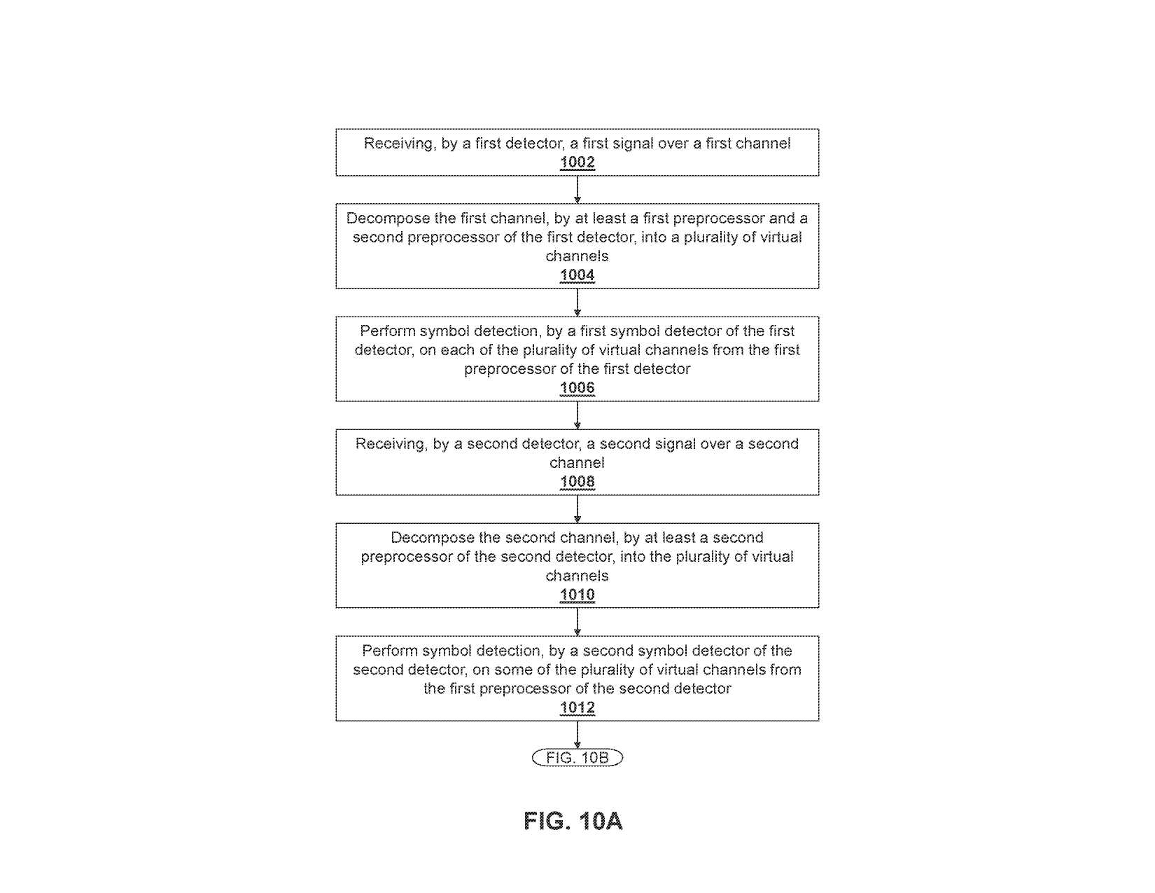

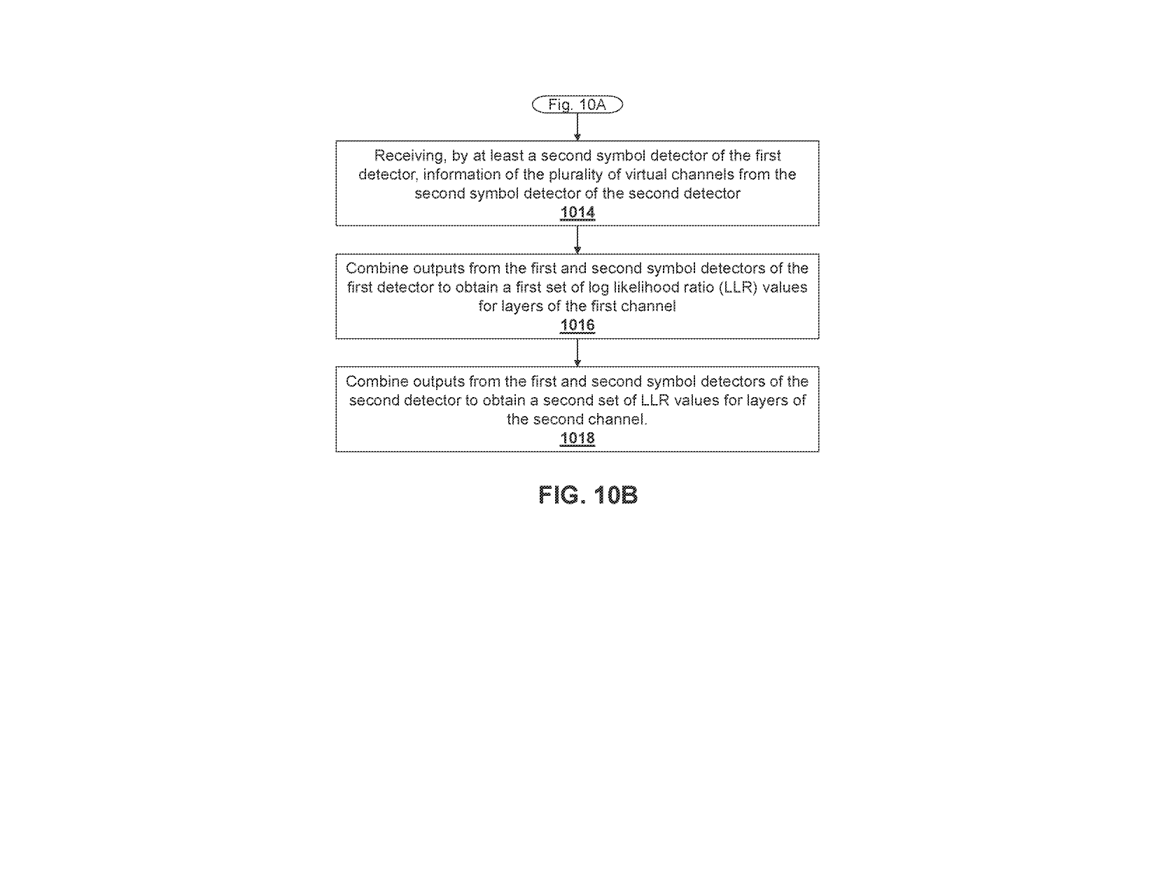

FIG. 10 is a flow chart illustrating another method for high-rank symbol detection, according to one or more embodiments. Although FIG. 10 illustrates various operations in a process for symbol detection, embodiments according to the present disclosure are not limited thereto, and according to some embodiments, the number or order of operations may vary. For example, some embodiments may include additional operations or fewer operations, or the order of operations may vary, unless otherwise stated or implied, without departing from the spirit and scope of embodiments according to the present disclosure.

Turning to FIG. 10, a high-rank symbol detector made of two sets of rank-N symbol detectors in parallel such as the one illustrated in FIG. 6 may be configured to receive a signal over a channel at operation 1002. For example, each detector set may include a plurality of preprocessors, each connected to rank-N/2 symbol detectors. At least a first preprocessor and a second preprocessor of the first detector may decompose the first channel into a plurality of virtual channels at operation 1004. Symbol detection may be performed by a first symbol detector of the first detector, on each of the plurality of virtual channels from the first preprocessor of the first detector at operation 1006. In some embodiments, the second detector set may receive a second signal over a second channel at operation 1008, and at least a second preprocessor of the second detector may decompose the second channel into the plurality of virtual channels at operation 1010. Symbol detection may be performed by a second symbol detector of the second detector on some of the plurality of virtual channels from the first preprocessor of the second detector at operation 1012. In other words, the symbol detection is not necessarily performed on all of the virtual channels, but instead, the second symbol detector of the first detector may receive information of the plurality of virtual channels from the second symbol detector of the second detector at operation 1014. Therefore, the symbols that are not detected by the second symbol detector of the second detector may be provided by from the second symbol detector of the other detector (e.g., the first detector).

Finally, the outputs from the first and second symbol detectors of the first detector may be combined to obtain LLR values for the layers of the first channel at operation 1016, and the outputs from the first and second symbol detectors of the second detector may be combined to obtain LLR values for the layers of the second channel at operation 1018. In some embodiments, the LLR values may be decoded to output decoded symbol value for the received signal.. In some embodiments, the first set of LLR values may be decoded to output a first decoded symbol value for the received first signal, and the second set of LLR values may be decoded to output a second decoded symbol value for the received second signal.

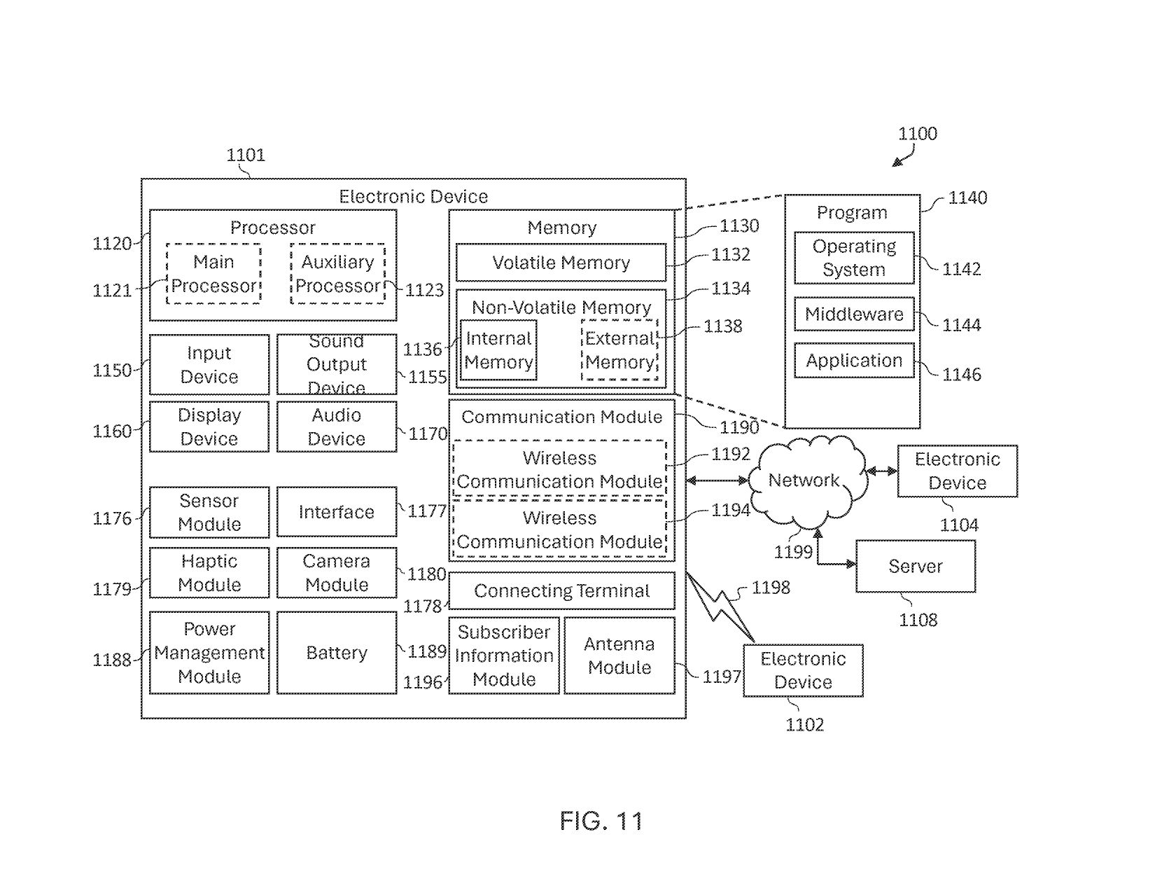

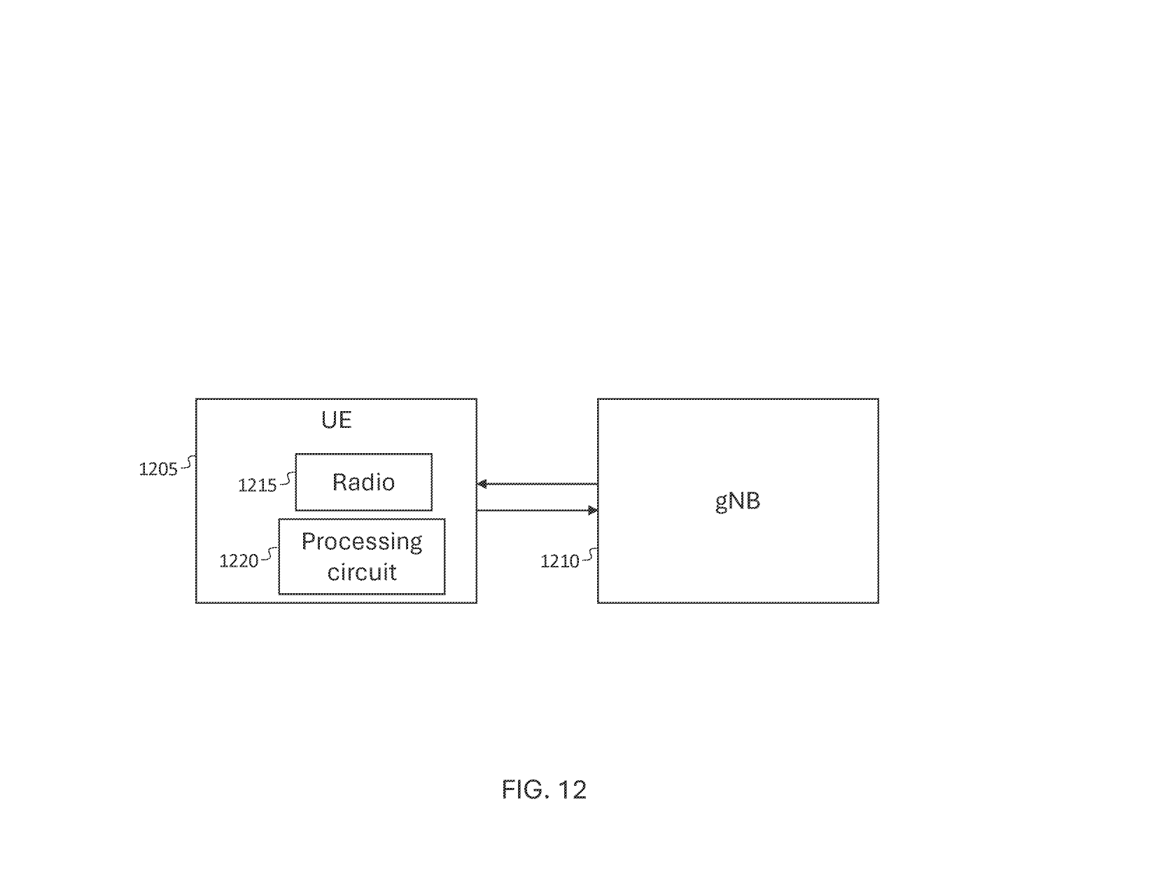

FIG. 11 is a block diagram of an electronic device such as a user equipment (UE) in a network environment 1100, according to an embodiment.

Referring to FIG. 11, an electronic device 1101 in a network environment 1100 may communicate with an electronic device 1102 via a first network 1198 (e.g., a short-range wireless communication network), or an electronic device 1104 or a server 1108 via a second network 1199 (e.g., a long-range wireless communication network). The electronic device 1101 may communicate with the electronic device 1104 via the server 1108. The electronic device 1101 may include a processor 1120, a memory 1130, an input device 1150, a sound output device 1155, a display device 1160, an audio module 1170, a sensor module 1176, an interface 1177, a haptic module 1179, a camera module 1180, a power management module 1188, a battery 1189, a communication module 1190, a subscriber identification module (SIM) card 1196, or an antenna module 1197. In one embodiment, at least one (e.g., the display device 1160 or the camera module 1180) of the components may be omitted from the electronic device 1101, or one or more other components may be added to the electronic device 1101. Some of the components may be implemented as a single integrated circuit (IC). For example, the sensor module 1176 (e.g., a fingerprint sensor, an iris sensor, or an illuminance sensor) may be embedded in the display device 1160 (e.g., a display).

The processor 1120 may execute software (e.g., a program 1140) to control at least one other component (e.g., a hardware or a software component) of the electronic device 1101 coupled with the processor 1120 and may perform various data processing or computations.

As at least part of the data processing or computations, the processor 1120 may load a command or data received from another component (e.g., the sensor module 1176 or the communication module 1190) in volatile memory 1132, process the command or the data stored in the volatile memory 1132, and store resulting data in non-volatile memory 1134. The processor 1120 may include a main processor 1121 (e.g., a central processing unit (CPU) or an application processor (AP)), and an auxiliary processor 1123 (e.g., a graphics processing unit (GPU), an image signal processor (ISP), a sensor hub processor, or a communication processor (CP)) that is operable independently from, or in conjunction with, the main processor 1121. Additionally or alternatively, the auxiliary processor 1123 may be adapted to consume less power than the main processor 1121, or execute a particular function. The auxiliary processor 1123 may be implemented as being separate from, or a part of, the main processor 1121.

The auxiliary processor 1123 may control at least some of the functions or states related to at least one component (e.g., the display device 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). The auxiliary processor 1123 (e.g., an image signal processor or a communication processor) may be implemented as part of another component (e.g., the camera module 1180 or the communication module 1190) functionally related to the auxiliary processor 1123.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134. Non-volatile memory 1134 may include internal memory 1136 and/or external memory 1138.

The program 1140 may be stored in the memory 1130 as software, and may include, for example, an operating system (OS) 1142, middleware 1144, or an application 1146.

The input device 1150 may receive a command or data to be used by another component (e.g., the processor 1120) of the electronic device 1101, from the outside (e.g., a user) of the electronic device 1101. The input device 1150 may include, for example, a microphone, a mouse, or a keyboard.

The sound output device 1155 may output sound signals to the outside of the electronic device 1101. The sound output device 1155 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1160 may visually provide information to the outside (e.g., a user) of the electronic device 1101. The display device 1160 may include, for example, a display, a hologram device, or a projector and control circuitry to control a corresponding one of the display, hologram device, and projector. The display device 1160 may include touch circuitry adapted to detect a touch, or sensor circuitry (e.g., a pressure sensor) adapted to measure the intensity of force incurred by the touch.

The audio module 1170 may convert a sound into an electrical signal and vice versa. The audio module 1170 may obtain the sound via the input device 1150 or output the sound via the sound output device 1155 or a headphone of an external electronic device 1102 directly (e.g., wired) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. The sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device 1102 directly (e.g., wired) or wirelessly. The interface 1177 may include, for example, a high- definition multimedia interface (HDMI), a universal serial bus (USB) interface, a secure digital (SD) card interface, or an audio interface.

A connecting terminal 1178 may include a connector via which the electronic device 1101 may be physically connected with the external electronic device 1102. The connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or an electrical stimulus which may be recognized by a user via tactile sensation or kinesthetic sensation. The haptic module 1179 may include, for example, a motor, a piezoelectric element, or an electrical stimulator.

The camera module 1180 may capture a still image or moving images. The camera module 1180 may include one or more lenses, image sensors, image signal processors, or flashes. The power management module 1188 may manage power supplied to the electronic device 1101. The power management module 1188 may be implemented as at least part of, for example, a power management integrated circuit (PMIC).

The battery 1189 may supply power to at least one component of the electronic device 1101. The battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the AP) and supports a direct (e.g., wired) communication or a wireless communication. The communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as BLUETOOTH^{TM}, wireless-fidelity (Wi-Fi) direct, or a standard of the Infrared Data Association (IrDA)) or the second network 1199 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The antenna module 1197 may transmit or receive a signal or power to or from the outside (e.g., the external electronic device) of the electronic device 1101. The antenna module 1197 may include one or more antennas, and, therefrom, at least one antenna appropriate for a communication scheme used in the communication network, such as the first network 1198 or the second network 1199, may be selected, for example, by the communication module 1190 (e.g., the wireless communication module 1192). The signal or the power may then be transmitted or received between the communication module 1190 and the external electronic device via the selected at least one antenna.

Commands or data may be transmitted or received between the electronic device 1101 and the external electronic device 1104 via the server 1108 coupled with the second network 1199. Each of the electronic devices 1102 and 1104 may be a device of a same type as, or a different type, from the electronic device 1101. All or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1101. The electronic device 1101 may provide the outcome, with or without further processing of the outcome, as at least part of a reply to the request. To that end, a cloud computing, distributed computing, or client-server computing technology may be used, for example.

FIG. 1212 shows a system including a UE 1205 and a gNB 1210, in communication with each other. The UE may include a radio 1215 and a processing circuit (or a means for processing) 1220, which may perform various methods disclosed herein, e.g., the method illustrated in FIG. 1. For example, the processing circuit 1220 may receive, via the radio 1215, transmissions from the network node (gNB) 1210, and the processing circuit 1220 may transmit, via the radio 1215, signals to the gNB 1210.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims and their equivalents.

What is claimed is:

1. A method comprising:
receiving a signal over a channel;
decomposing the channel into a plurality of virtual channels;
performing symbol detection by two or more symbol detectors on the plurality of virtual channels, wherein at least one of the two or more symbol detectors comprises less than all of the plurality of virtual channels; and
combining outputs from the two or more symbol detectors to obtain log likelihood ratio (LLR) values for layers of the channel.

2. The method of claim 1, wherein the performing the symbol detection comprises performing a first symbol detection by a first symbol detector on each of the plurality of virtual channels from a first preprocessor.

3. The method of claim 2, wherein the performing the symbol detection further comprises performing a second symbol detection by a second symbol detector on each of the plurality of virtual channels from a second preprocessor, wherein the second symbol detector comprises fewer layers than the first symbol detector.

4. The method of claim 3, wherein the first symbol detector is a rank-N/2 symbol and the second symbol detector is a rank-N/4 symbol detector.

5. The method of claim 1, wherein the decomposing the channel comprises decomposing the channel by a first preprocessor, the method further comprising receiving, by at least a second preprocessor, information from some of the plurality of virtual channels from the first preprocessor.

6. The method of claim 5, wherein the performing the symbol detection comprises:
performing a first symbol detection by a first symbol detector on each of the plurality of virtual channels from the first preprocessor; and
performing a second symbol detection by a second symbol detector on less than all of the plurality of virtual channels from the second preprocessor.

7. The method of claim 6, wherein the decomposing the channel is performed by at least the first preprocessor and the second preprocessor, and comprises performing interference whitening on one or more layers of the channel.

8. The method of claim 6,
wherein the first symbol detector is a rank-N/2 symbol detector and the first symbol detection is performed on N/2 layers, and
wherein the second symbol detector is a rank-N/2 symbol detector, and the second symbol detection is performed on N/4 layers.

9. The method of claim 1, wherein the decomposing the channel comprises decomposing the channel by a first preprocessor, the method further comprising receiving, by at least a second preprocessor, information from some virtual channels of the plurality of virtual channels from the first preprocessor.

10. A system comprising:
a processor; and
a memory storing instructions executed by the processor to cause the processor to:
receive a signal over a channel;
decompose the channel into a plurality of virtual channels;
perform symbol detection by two or more symbol detectors on the plurality of virtual channels, wherein at least one of the two or more symbol detectors comprises less than all of the plurality of virtual channels; and
combine outputs from the two or more symbol detectors to obtain log likelihood ratio (LLR) values for layers of the channel.

11. The system of claim 10, wherein the performing the symbol detection comprises performing a first symbol detection by a first symbol detector on each of the plurality of virtual channels from a first preprocessor.

12. The system of claim 11, wherein the performing the symbol detection further comprises performing a second symbol detection by a second symbol detector on each of the plurality of virtual channels from a second preprocessor, wherein the second symbol detector comprises fewer layers than the first symbol detector.

13. The system of claim 12, wherein the first symbol detector is a rank-N/2 symbol and the second symbol detector is a rank-N/4 symbol detector.

14. The system of claim 10, wherein the decomposing the channel comprises decomposing the channel by a first preprocessor, and wherein the processor further receives, by at least a second preprocessor, information from some of the plurality of virtual channels from the first preprocessor.

15. The system of claim 14, wherein the performing the symbol detection comprises:
performing a first symbol detection by a first symbol detector on each of the plurality of virtual channels from the first preprocessor; and
performing a second symbol detection by a second symbol detector on less than all of the plurality of virtual channels from the second preprocessor.

16. The system of claim 15, wherein the decomposing the channel is performed by at least the first preprocessor and the second preprocessor, and the processor further performs interference whitening on one or more layers of the channel.

17. The system of claim 15,
wherein the first symbol detector is a rank-N/2 symbol detector and the first symbol detection is performed on N/2 layers, and
wherein the second symbol detector is a rank-N/2 symbol detector, and the second symbol detection is performed on N/4 layers.

18. The system of claim 10, wherein the decomposing the channel comprises decomposing the channel by a first preprocessor, and wherein the processor further receives, by at least a second preprocessor, information from some virtual channels of the plurality of virtual channels from the first preprocessor.

19. A method comprising:
receiving, by a first detector, a first signal over a first channel;
decomposing the first channel into a plurality of virtual channels;
performing first symbol detection, by a first symbol detector of the first detector, on each of the plurality of virtual channels from a first preprocessor of the first detector;
receiving, by a second detector, a second signal over a second channel;
decomposing the second channel into the plurality of virtual channels;
performing second symbol detection, by a second symbol detector of the second detector, on some of the plurality of virtual channels from the first preprocessor of the second detector;
receiving, by at least a second symbol detector of the first detector, information of the plurality of virtual channels from the second symbol detector of the second detector;
combining outputs from the first and second symbol detectors of the first detector to obtain a first set of log likelihood ratio (LLR) values for layers of the first channel; and
combining outputs from the first and second symbol detectors of the second detector to obtain a second set of LLR values for layers of the second channel.

20. The method of claim 19, further comprising:
performing a first decoding using the first set of LLR values to output a first decoded symbol value for the received first signal; and
performing second decoding using the second set of LLR values to output a second decoded symbol value for the received second signal.
